(19) United States
(12) Patent Application Publication
(10) Pub. No.: US 2015/0379916 A1
(43) Pub. Date: Dec. 31, 2015

(54) DISPLAY PANEL AND DISPLAY METHOD THEREOF, AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Renwei GUO, Beijing (CN); Xue DONG, Beijing (CN); Peng LIU, Beijing (CN)

(21) Appl. No.: 14/415,878

(22) PCT Filed: Jun. 30, 2014
(86) PCT No.: PCT/CN2014/081194

§ 371 Date: Jan. 20, 2015

(30) Foreign Application Priority Data
Dec. 16, 2013 (CN) 201310686485.X

(51) Int. Cl. G09G 3/20; G09G 3/32; G09G 3/36

(52) U.S. Cl. CPC G09G 3/2074; G09G 3/2003; G09G 3/3607; G09G 3/3208; G09G 2300/0452; G09G 2340/0457

(57) ABSTRACT

The present invention provides a display panel and a display method thereof, and a display device. The display panel comprises a plurality of circulation units, each circulation unit is composed of two rows of sub-pixels, the sub-pixels in each row include one red sub-pixel, one green sub-pixel and one blue sub-pixel, and the sub-pixels in a first row are provided to shift by a half size of the sub-pixel in a row direction with respect to the sub-pixels in a second row, respectively, and an arrangement mode of the sub-pixels in the first row is different from that of the sub-pixels in the second row. The display method comprises: determining initial components of the sub-pixels according to a picture to be displayed; and determining a display component of a sub-pixel according to the initial components of the sub-pixel and common sub-pixels of the sub-pixel.

### FIELD OF THE INVENTION

The present invention relates to the field of display technology, and in particular, relates to a display panel and a display method thereof and a display device.

### BACKGROUND OF THE INVENTION

In a conventional liquid crystal display device or organic light emitting diode (OLED) display device, each point (pixel) displays colors by a plurality of sub-pixels through light mixing, e.g. each pixel is composed of a red sub-pixel, a green sub-pixel and a blue sub-pixel (i.e., in RGB mode). To improve the visual effect, the requirement for resolution (the number of pixels in a unit size) of a display device is increasingly high, this requires increasingly small size of the sub-pixels, but the size of the sub-pixels cannot be infinitely reduced due to process limitation. To improve the display effect under the condition that the size of the sub-pixels is definite, a display device of a Pentile mode is proposed. In the display device of the Pentile mode, the number of sub-pixels of part of colors (e.g. red sub-pixels and blue sub-pixels) is halved, meanwhile, in the display device, the sub-pixels of different colors are virtualized as in different “layers”, each layer is divided into a plurality of sampling areas, the divided sampling areas of each layer are not superposed, and then the content to be displayed by each sub-pixel is calculated by using an area ratio of the sampling areas. A part of the sub-pixels in the display device of the Pentile mode are “shared”, so that a resolution higher than the practical resolution is achieved on the visual effect.

However, the display effect of the existing display device of the Pentile mode is still not ideal. Since the number of the sub-pixels of part of colors is halved, the sub-pixels of various colors are not uniformly distributed, and the problems of serrated grains, latticed spots, unclear display of small contents and the like are easily caused. Meanwhile, due to a calculation mode of “layer and area division”, a complex calculation process is needed for calculating the content which needs to be displayed by each sub-pixel, and the calculation quantity is large.

### SUMMARY OF THE INVENTION

For solving the technical problems of poor display effect and large calculation quantity in the existing high-resolution display technology, the present invention provides a display panel and a display method thereof and a display device with high resolution, good display effect and small required calculation quantity.

According to an aspect of the present invention, there is provided a display panel comprising a plurality of circulation units, each circulation unit is composed of two rows of sub-pixels, the sub-pixels in each row include one red sub-pixel, one green sub-pixel and one blue sub-pixel, and the sub-pixels in a first row are provided to shift by a half size of the sub-pixel in a row direction with respect to the sub-pixels in a second row, respectively, and an arrangement mode of the sub-pixels in the first row is different from that of the sub-pixels in the second row.

The above-mentioned “row” is described with respect to the arrangement mode of the sub-pixels, and all sub-pixels in a “row” are arranged in a straight line. The sub-pixels adjacent to each other along the “column” direction perpendicular to the “row” direction shift by the half size of the sub-pixel with respect to each other, i.e., the sub-pixels in a “column” are not arranged in a straight line, or the sub-pixels in a “column” are arranged to shift by the half size of the sub-pixel in a row direction with respect to each other. Accordingly, the “row” and the “column” are irrelevant with the shape (rectangular, circular or special-shaped) of the sub-pixels, the placement manner (placed vertically, placed horizontally, upright, inverted or the like) of the display panel, and the arrangement modes of a gate line and a data line. For example, when a display panel is placed normally, each line of sub-pixels parallel to the ground may be considered as a “row”, or each line of sub-pixels perpendicular to the ground may be considered as a “row”.

In the display panel, “the sub-pixels in the first row are provided to shift by a half size of the sub-pixel in a row direction with respect to the sub-pixels in the second row” means that, the corresponding sub-pixels (e.g., the first sub-pixels) in two rows of the circulation unit are not arranged in a straight line in a column direction, and there exists a difference of the half size of the sub-pixel between the corresponding sub-pixels, i.e., after a center of a certain sub-pixel in a row is projected onto the adjacent row along a column direction, said center corresponds to a center of a connection line between two sub-pixels in the adjacent row rather than a center of the corresponding sub-pixel in the adjacent row.

In the display panel, the sub-pixels in the circulation unit has an arrangement mode of any one of the followings: 1) the first row from left to right orderly include R, B and G, and the second row from left to right orderly include G, R and B; 2) the first row from left to right orderly include B, R and G, and the second row from left to right orderly include G, B and R; 3) the first row from left to right orderly include B, G and R, and the second row from left to right orderly include R, B and G; 4) the first row from left to right orderly include G, B and R, and the second row from left to right orderly include R, G and B; 5) the first row from left to right orderly include G, R and B, and the second row from left to right orderly include B, G and R; 6) the first row from left to right orderly include R, G and B, and the second row from left to right orderly include B, R and G; 7) the first row from left to right orderly include R, B and G, and the second row from left to right orderly include G, B and R; 8) the first row from left to right orderly include B, R and G, and the second row from left to right orderly include G, R and B; 9) the first row from left to right orderly include B, G and R, and the second row from left to right orderly include R, G and B; 10) the first row from left to right orderly include G, B and R, and the second row from left to right orderly include R, B and G; 11) the first row from left to right orderly include G, R and B, and the second row from left to right orderly include B, R and G; 12) the first row from left to right orderly include R, G and B, and the second row from left to right orderly include B, G and R; 13) the first row from left to right orderly include R, B and G, and the second row from left to right orderly include B, G and R; 14) the first row from left to right orderly include B, R and G, and the second row from left to right orderly include R, G and B; 15) the first row from left to right orderly include B, G and R, and the second row from left to right orderly include G, R and B; 16) the first row from left to right orderly include G, B and R, and the second row from left to right orderly include B, R and G; 17) the first row from left to right orderly include G, R and B, and the second row from left to right orderly include R, B and G; and 18) the first row from left to right orderly include R, G and B, and the second row from left to right orderly include G, B and R, wherein R indicates a red sub-pixel, G indicates a green sub-pixel, and B indicates a blue sub-pixel, and the sub-pixels in the first row may be arranged to shift by the half size of the sub-pixel in any one extending direction of two extending directions of the row direction with respect to the sub-pixels in the second row, respectively.

The circulation units are arranged into a matrix and throughout a display region of the display panel.

According to another aspect of the present invention, there is provided a display device comprising the above-mentioned display panel.

In the display device and the display panel of the embodiment of the present invention, the sub-pixels of each color are equal in number and are uniformly distributed, so that serrated grains, latticed spots and the like are not produced. Moreover, the sub-pixels of different rows are arranged in a specific manner of “shifting by the half size of the sub-pixel” in the row direction, and a specific display method of “sub-region sampling” is utilized, so that a higher resolution may be realized on the visual effect, color transition is uniform and natural, and better display effect is achieved. Meanwhile, the calculation quantity in the display process is small and the method is easy to be realized.

According to yet another aspect of the present invention, there is provided a display method of the above display panel, comprising steps of: determining initial components of the sub-pixels according to a picture to be displayed; and determining a display component of a sub-pixel according to the initial components of the sub-pixel and common sub-pixels of the sub-pixel, wherein the common sub-pixels of the sub-pixel are a plurality of sub-pixels around the sub-pixel and with the same color as the sub-pixel.

The “initial component” refers to original content to be displayed (or, “quantity” to be displayed) by each sub-pixel according to the picture to be displayed, i.e., the content to be displayed by using existing display method, and the “display component” refers to the content to be displayed actually by each sub-pixel, which is obtained by performing calculation by the method of the present invention.

The initial component and the display component may be any one of brightness, grayscale and saturation.

Before determining the display component of the sub-pixel according to the initial components of the sub-pixel and common sub-pixels of the sub-pixel, the display method may further comprise a step of: determining the common sub-pixels of the sub-pixels according to the picture to be displayed.

The step of determining the common sub-pixels of the sub-pixels according to the picture to be displayed may comprise: determining the common sub-pixels by determining whether the content of the picture to be displayed is a picture having uniform transition and little color change or a picture having large color change.

The step of determining the display component of the sub-pixel according to the initial components of the sub-pixel and common sub-pixels of the sub-pixel may comprise: multiplying the initial components of the sub-pixel and the common sub-pixels of the sub-pixel by respective scale factors, and summing up resulting values as the display component of the sub-pixel, wherein the scale factors of the sub-pixel and the common sub-pixels are positive numbers.

The sum of the scale factors of the sub-pixel and the common sub-pixels thereof may be 1, and the scale factor of the sub-pixel may be larger than those of the common sub-pixels.

The common sub-pixels of the sub-pixel may include: four sub-pixels with the same color as the sub-pixel respectively in two rows adjacent to the row of the sub-pixel, and respectively on two sides of the sub-pixel in the row direction and closest to the sub-pixel.

The common sub-pixels of the sub-pixel may include: two sub-pixels with the same color as the sub-pixel respectively in two rows adjacent to the row of the sub-pixel, and on a same side of the sub-pixel in the row direction and closest to the sub-pixel.

The common sub-pixels of one sub-pixel may include: two sub-pixels with the same color as the sub-pixel in a row adjacent to the row of the sub-pixel, and respectively on two sides of the sub-pixel in the row direction and closest to the sub-pixel.

In the display method of the embodiment of the present invention, the sub-pixels of different rows are arranged in a specific manner of “shifting by the half size of the sub-pixel” in the row direction, and the content displayed by the sub-pixel is determined together by the original contents to be displayed by the sub-pixel itself and the plurality of the sub-pixels with the same color around the sub-pixel, i.e., the content displayed by the sub-pixel is a result of “sub-region sampling”, so that a higher resolution may be realized on the visual effect, color transition is uniform and natural, and better display effect is achieved. Meanwhile, the calculation quantity in the display process is small and the method is easy to be realized.

### BRIEF DESCRIPTION OF THE DRAWINGS

FIG. 1 is a schematic diagram of a display panel of an embodiment of the present invention.

FIG. 2 is a schematic diagram of sub-pixel arrangement modes in a circulation unit of a display panel of an embodiment of the present invention.

FIG. 3 is a schematic diagram of sub-regions of red sub-pixel “layer” in a display panel of an embodiment of the present invention.

FIG. 4 is a schematic diagram of a selection method of common sub-pixels in a display panel of an embodiment of the present invention.

FIG. 5 is a schematic diagram of another selection method of common sub-pixels in a display panel of an embodiment of the present invention.

FIG. 6 is a schematic diagram of another selection method of common sub-pixels in a display panel of an embodiment of the present invention.

FIG. 7 is a schematic diagram of a selection method of common sub-pixels in a display panel of an embodiment of the present invention.

FIG. 8 is a schematic diagram of another selection method of common sub-pixels in a display panel of an embodiment of the present invention.

### DESCRIPTION OF THE PREFERRED EMBODIMENT

To make those skilled in the art better understand the technical solutions of the present invention, the present invention will be further described in detail below in combination with the accompanying drawings and specific implementations.

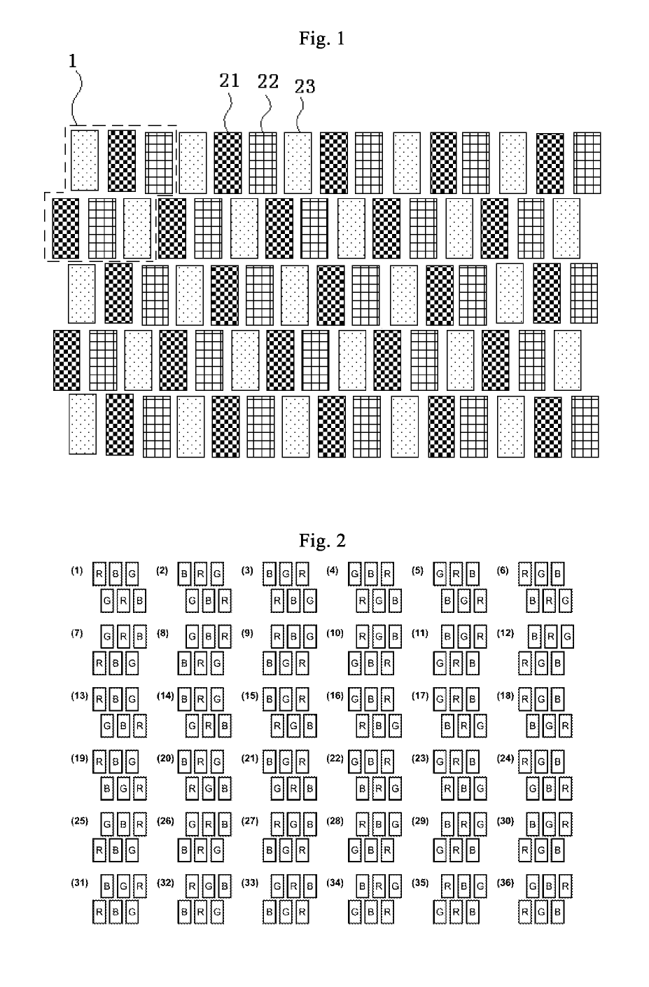

As shown in FIG. 1, a display panel is provided according to an embodiment of the present invention, the display panel comprises a plurality of circulation units 1, each circulation unit 1 is composed of two rows of sub-pixels, the sub-pixels in each row include one red sub-pixel 21, one green sub-pixel 22 and one blue sub-pixel 23, the sub-pixels in a first row are provided to shift by a half size of the sub-pixel in a row direction with respect to the sub-pixels in a second row, respectively, and an arrangement mode of the sub-pixels in the first row is different from an arrangement mode of the sub-pixels in the second row.

That is to say, each circulation unit 1 is composed of six sub-pixels, i.e., two red sub-pixels 21, two green sub-pixels 22 and two blue sub-pixels 23, and the six sub-pixels are divided into two rows, each row comprises three different sub-pixels, i.e., one red sub-pixel 21, one green sub-pixel 22 and one blue sub-pixel 23. The arrangement modes of two rows of the sub-pixels are different from each other, for example, if one row from left to right comprises the red sub-pixel 21, the green sub-pixel 22 and the blue sub-pixel 23, the sub-pixels in the other row must have another different arrangement mode. Meanwhile, the two rows of the sub-pixels are not aligned with each other, a difference of a half size of the sub-pixel is provided between the first row of the sub-pixels and the second row of the sub-pixels. Therefore, for example, when each circulation unit is regarded as a “point” and the “points” are arranged into a matrix throughout a display region of the display panel, the arrangement mode of the sub-pixels shown in FIG. 1 is obtained in the entire display panel.

For example, the arrangement mode of the sub-pixels in the circulation unit 1 may be any one of thirty six arrangement modes shown in FIG. 2, in which R indicates the red sub-pixel 21, G indicates the green sub-pixel 22 and B indicates the blue sub-pixel 23. Preferably, the arrangement mode of the sub-pixels in the circulation unit 1 may be any one of (1) to (12) arrangement modes shown in FIG. 2. Researches discover that, when a display method of an embodiment of the present invention is utilized, a “sub-region 3” (which is described in detail below) of the sub-pixels in the display panel adopting any one of the twelve arrangement modes has a more regular shape and is easier to be realized, and the display panel has a better display effect.

Each sub-pixel in the display panel may independently emit light with required color and brightness. Generally, the sub-pixels are controlled by a thin-film transistor array (active drive array), each sub-pixel corresponds to at least one thin-film transistor (for an organic light emitting diode display device, each sub-pixel corresponds to a plurality of thin-film transistors), and the thin-film transistors are arranged to form an array and controlled by gate lines and data lines.

For example, the display panel may be an organic light emitting diode display panel, each sub-pixel comprises a light emitting unit, and the colors of light emitted by the light emitting units of the sub-pixels correspond to the colors of the three color sub-pixels. That is to say, the display panel of an embodiment of the present invention may be an organic light emitting diode display panel, wherein an organic light emitting diode (light emitting unit) is provided at each sub-pixel, the organic light emitting diodes may emit light with different colors (which may be realized by using different organic light emitting layers), and the color of light emitted by each organic light emitting diode is the same as that of the sub-pixel where the organic light emitting diode is located, e.g. the organic light emitting diode at the red sub-pixel 21 emits red light, etc.

Furthermore, the display panel may also be a liquid crystal display panel, the sub-pixel of the display panel comprises a filter unit, and the colors of light penetrating through the filter units of the sub-pixels correspond to the colors of the three color sub-pixels. That is to say, the display panel of an embodiment of the present invention may also be a liquid crystal display panel, the liquid crystal display panel itself does not emit light, and light coming from a back light source is filtered by the filter units to realize color display, wherein a color filter membrane (filter unit) with different color is arranged at each sub-pixel, light penetrating through the color filter membrane may be converted to the corresponding color, and the color of the color filter membrane at each sub-pixel is the same as the color of the sub-pixel, e.g. the color filter membrane at the red sub-pixel 21 is red, etc.

Certainly, other types of display panels are also feasible, as long as lights with corresponding colors are emitted at the sub-pixels, and the different types of display panels may adopt known structures and therefore are no longer described in detail herein.

According to an embodiment of the present invention, there is further provided a display device, comprising the above-mentioned display panel.

In the display device and the display panel of the embodiments of the present invention, the sub-pixels of each color are equal in number and are uniformly distributed, so that serrated grains, latticed spots and the like are not produced. Moreover, the sub-pixels of different rows are arranged in a specific manner, i.e., the sub-pixels of the first row “shift by the half size of the sub-pixel” in the row direction with respect to the sub-pixels of the second row, and a specific display method of “sub-region sampling” is utilized, so that a higher resolution may be realized on the visual effect, color transition is uniform and natural, and better display effect is achieved. Meanwhile, the calculation quantity in the display process is small and the method is easy to be realized.

In order to achieve higher resolution and better display effect on the basis of the above display panel, a display method of the above display panel is provided according to an embodiment of the present invention, the display method comprises following steps S01, S02 and S03.

In step S01, initial components of the sub-pixels are determined according to a picture to be displayed.

In this step, “initial component” refers to original content to be displayed by each sub-pixel in the display panel by using existing display method according to the picture to be displayed (or, “quantity” to be displayed), i.e., the original content to be displayed before calculating by using the display method of the embodiment of the present invention.

For example, the initial component and display component mentioned below refer to brightness. That is to say, the “quantity” of each color to be displayed is indicated by the “brightness”.

Of course, the initial component may also utilize other unit of measure, as long as the “component” indicates the “quantity” corresponding to each color to be displayed, for example, the unit of “component” may be “grayscale”. The “grayscale” is a gradation index of display brightness in the display field, e.g., for the display panel of 256 grayscales, the grayscale corresponding to the lowest brightness is 0, and the grayscale corresponding to the highest brightness is 255. Further, for example, “saturation” may also be used as the “component”, the “saturation” represents the level of the color deviated from the gray with the same brightness, i.e., it indicates the level of vividness.

In step S02, common sub-pixels of the sub-pixels are determined according to the picture to be displayed.

That is to say, the common sub-pixels of the sub-pixels are determined according to specific circumstance of the picture to be displayed, and the common sub-pixels of one sub-pixel are a plurality of sub-pixels around the sub-pixel and having the same color as the sub-pixel.

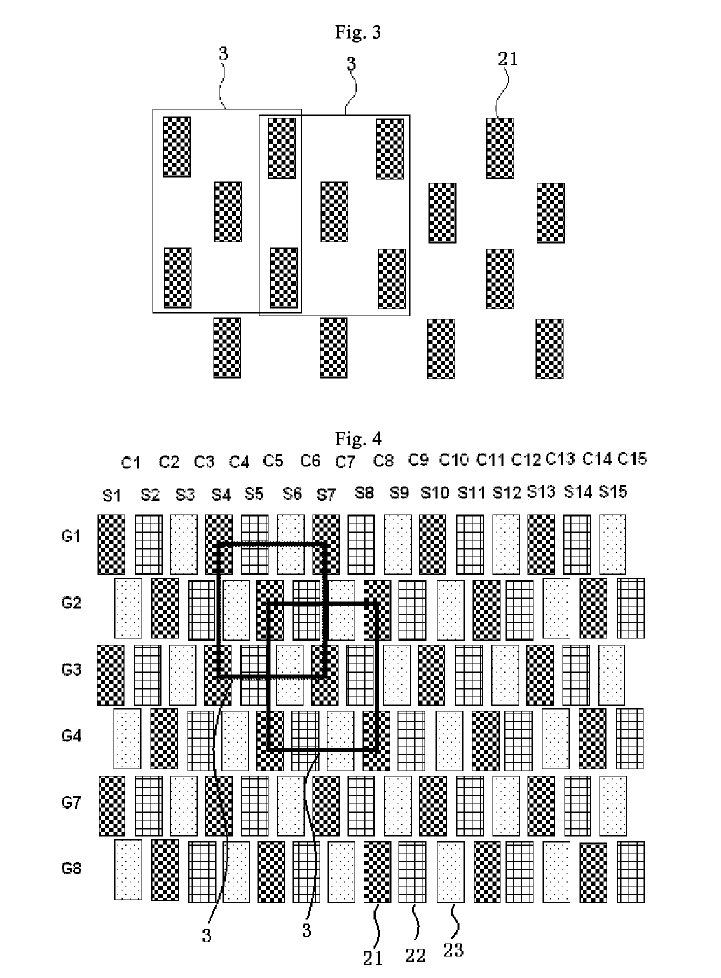

In the embodiment of the present invention, the content to be displayed by each sub-pixel is determined by a method of “sub-region sampling”. Specifically, the sub-pixels with the different colors are regarded as in the different “layers”, and each “layer” only comprises the sub-pixels of one color (e.g., a “layer” of red sub-pixels 21 shown in FIG. 3). Then, the “layer” is divided into a plurality of “sub-regions 3” (different sub-regions may partially overlap with each other). When display is performed at a certain sub-pixel, the content to be displayed is determined by all sub-pixels in the “sub-region 3” where the sub-pixel is located (as long as the sub-pixel is partially located in the “sub-region 3”). That is to say, the content to be displayed by each sub-pixel is determined by itself and the common sub-pixels together. Therefore, the selection method of the common sub-pixel is important.

For example, the common sub-pixels of one sub-pixel may include four sub-pixels with the same color as the sub-pixel respectively in two rows adjacent to the row of the sub-pixel, and respectively on two sides of the sub-pixel in the row direction and closest to the sub-pixel.

That is to say, as shown in FIG. 4, the “sub-region 3” is a rectangle, i.e., for the red sub-pixel 21 of coordinate (C5, G2), the common sub-pixels include four red sub-pixels 21 of coordinates (S7, G1), (S7, G3), (S4, G3) and (S4, G1); and for the red sub-pixel 21 of coordinate (S7, G3), the common sub-pixels include four red sub-pixels 21 of coordinates (C8, G2), (C8, G4), (C5, G4) and (C5, G2). As in such manner, the four common sub-pixels of a certain sub-pixel constitute a “rectangle”, and the sub-pixel is enclosed in the “rectangle”.

The meaning of the coordinate system in the embodiment of the present invention is as follows: “Gx” indicates a longitudinal coordinate, and Cx and Sx indicate two horizontal coordinates; Sx indicates a horizontal coordinate of the sub-pixel in an odd row (i.e., G1, G3 or G5 etc.), and Cx indicates a horizontal coordinate of the sub-pixel in an even row (i.e., G2, G4 or G6 etc.), the two horizontal coordinates do not affect each other.

In addition, the common sub-pixels of one sub-pixel may include two sub-pixels with the same color as the sub-pixel respectively in two rows adjacent to the row of the sub-pixel, and on a same side of the sub-pixel in the row direction and closest to the sub-pixel.

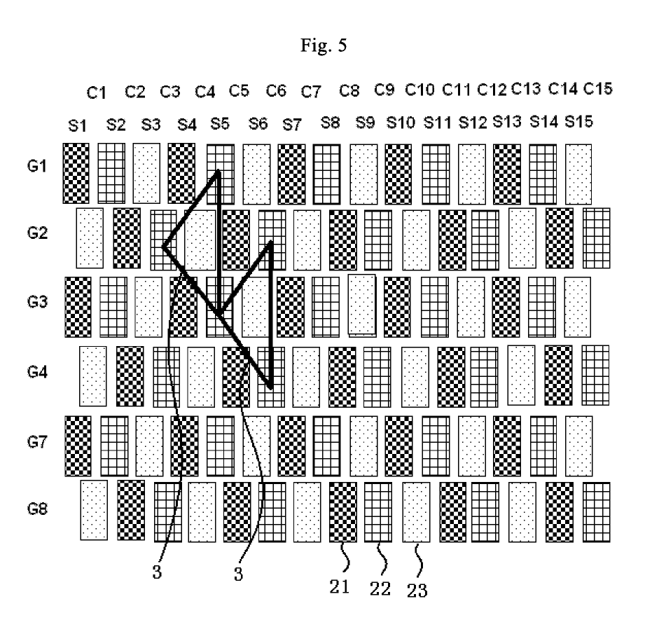

That is to say, as shown in FIG. 5, the “sub-region 3” may also be a “triangle (e.g., isosceles triangle)”, i.e., for the green sub-pixel 22 of coordinate (C3, G2), the common sub-pixels include two green sub-pixels 22 of coordinates (S5, G1) and (S5, G3); and for the green sub-pixel 22 of coordinate (S5, G3), the common sub-pixels include two green sub-pixels 22 of coordinates (C6, G2) and (C6, G4). As in such manner, a certain sub-pixel and the common sub-pixels of the certain sub-pixel constitute a “triangle”, and the connection line between the two common sub-pixels is parallel with the column direction.

In addition, the common sub-pixels of one sub-pixel may include two sub-pixels with the same color as the sub-pixel in a row adjacent to the row of the sub-pixel, and respectively on two sides of the sub-pixel in the row direction and closest to the sub-pixel.

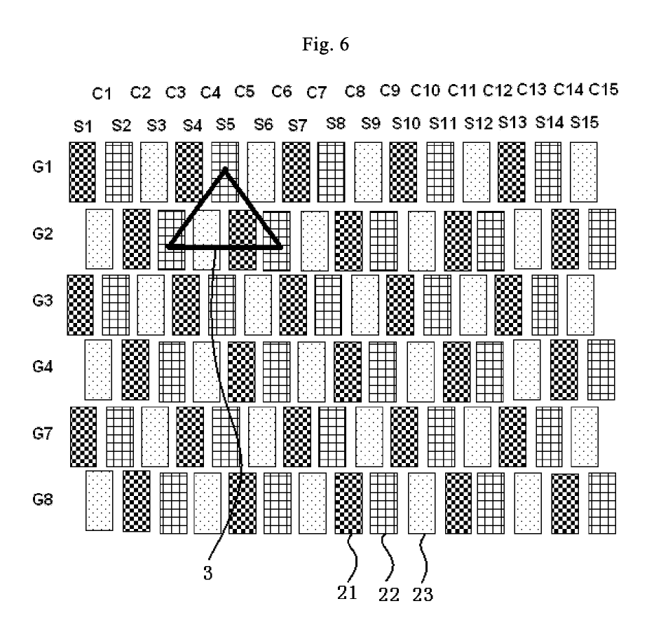

That is to say, as shown in FIG. 6, the “sub-region 3” may also be another different “triangle”, i.e., for the green sub-pixel 22 of coordinate (S5, G1), the common sub-pixels include two green sub-pixels 22 of coordinates (C3, G2) and (C6, G2). In this case, a certain sub-pixel and the common sub-pixels of the certain sub-pixel also constitute a “triangle”, the difference is that the connection line between the two common sub-pixels is parallel with the row direction rather than the column direction.

The above several selection methods of the common sub-pixels (in other words, division methods of “sub-regions 3”) are simple, the obtained “sub-region 3” is regular and uniform, so that better display effect is achieved and the method is easy to be realized.

It should be understood that, the above selection methods of the common sub-pixels are not intend to limit the present invention, the sub-pixels close to a certain sub-pixel and with the same color as the sub-pixel may be used as the common sub-pixels of the sub-pixel. For example, the “rectangle” sub-region in FIG. 4 may be enlarged to contain more common sub-pixels. Further, for the “triangle” sub-region in FIG. 5 and FIG. 6, although the common sub-pixels of a certain sub-pixel are provided at “right side” or “lower side” of the sub-pixel, the common sub-pixels of a certain sub-pixel may also be provided at “left side” or “upper side” of the sub-pixel.

In addition, apparently, although the selection methods of the common sub-pixels of sub-pixels at edges of the display panel may be different from those of the common sub-pixels of sub-pixels at middle of the display panel, it does not have an impact on realization of the present invention.

In step S02, specifically, “determining common sub-pixels of the sub-pixels according to the picture to be displayed” refers to analyzing the content of the picture to be displayed and determining a selection method of the common sub-pixels according to the analysis result.

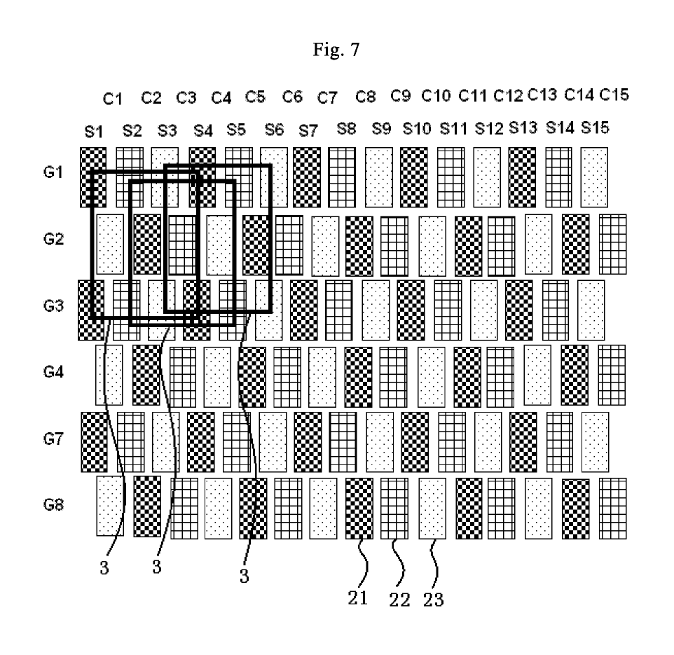

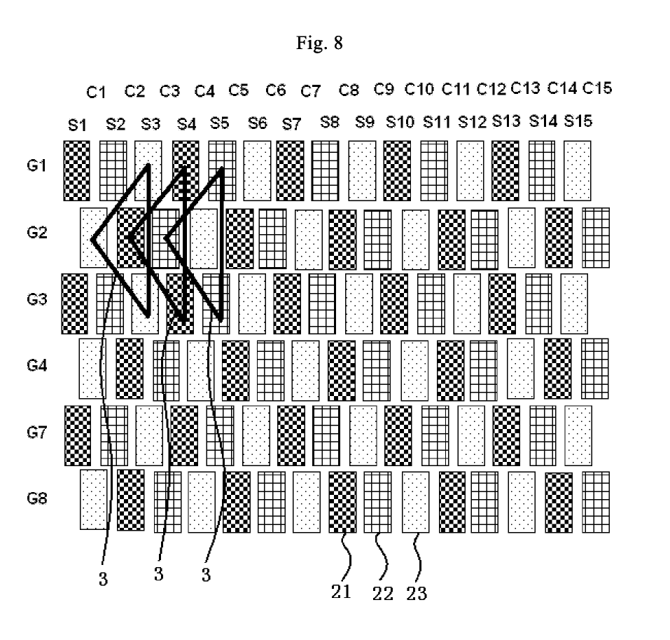

For example, as shown in FIG. 7, when the “sub-region 3” of the “rectangle” is utilized, if the common sub-pixels of the red sub-pixel 21 of coordinate (C2, G2), the green sub-pixel 22 of coordinate (C3, G2) and the blue sub-pixel 23 of coordinate (C4, G2) are going to be selected respectively, the obtained three “sub-regions 3” have relatively large “overlapped” portions therebetween, and researches discover that, display effect may be better when such method is applied to the picture having uniform transition and little color change. As shown in FIG. 8, when the “sub-region 3” of the “triangle” is utilized, if the common sub-pixels of the blue sub-pixel 23 of coordinate (C1, G2), the red sub-pixel 21 of coordinate (C2, G2) and the green sub-pixel 22 of coordinate (C3, G2) are going to be selected respectively, the obtained three “sub-regions 3” have relatively small “overlapped” portions therebetween, and researches discover that, display effect may be better when such method is applied to the picture having larger change. For this reason, an analysis may be performed on a frame of picture, “the sub-region 3” of the “rectangle” is utilized if the picture is uniform overall, and “the sub-region 3” of the “triangle” is utilized otherwise. Alternatively, an analysis may be performed on each part of the picture, “the sub-region 3” of the “rectangle” is utilized for the uniform part (e.g., internal part of an object in the picture), and “the sub-region 3” of the “triangle” is utilized for the part having significant change (e.g., at junction of two objects).

In general, the specific method of determining the common sub-pixels of the sub-pixels according to the picture to be displayed is diverse, and more detailed description thereto is omitted herein.

Of course, it should be understood that, if step S02 is not performed, all pictures may be displayed according to predetermined “sub-regions 3” (or selection method of the common sub-pixels).

In step S03, a display component of a sub-pixel is determined according to the initial components of the sub-pixel and the common sub-pixels of the sub-pixel.

That is to say, when a certain sub-pixel is going to display, it does not display the initial component thereof directly, but a calculation is performed on the initial components of the sub-pixel and the common sub-pixels of the sub-pixel, and the display component to be displayed actually is finally obtained according to the initial components. The final content to be displayed by the sub-pixel is affected by the common sub-pixels of the sub-pixel, that is, this step is equivalent of sampling all sub-pixels in the “sub-region 3” of the sub-pixel, thus this step is referred to as “sub-region sampling” process.

Specifically, this step may comprise multiplying the initial components of a sub-pixel and the common sub-pixels of the sub-pixel by the respective scale factors, and summing up the resulting values as the display component of the sub-pixel, the scale factors of the sub-pixel and the common sub-pixels are positive numbers.

Apparently, statuses of different sub-pixels (including the certain sub-pixel and the common sub-pixels thereof, or the sub-pixels at different positions among the common sub-pixels) during displaying are different. For this reason, “weight ratios” of different sub-pixels are also different during the “sub-region sampling”, and the “weight ratios” may be realized by multiplying the initial components of different sub-pixels by the respective scale factors. The “scale factors” corresponding to the initial components are the coefficients set artificially, and plays a role of adjusting final display content and achieving optimized display effect. Therefore, the values of the “scale factors” may be set and adjusted according to the experience and the actual situation.

For example, the sum of the scale factors of a sub-pixel and the common sub-pixels thereof is 1, and the scale factor of the sub-pixel is larger than those of the common sub-pixels.

That is to say, the scale factor of a sub-pixel and the scale factors of the common sub-pixels of the sub-pixel may be the positive numbers smaller than 1 and the sum of the scale factors is 1. Among the scale factors, the scale factor of the sub-pixel itself is larger than any other scale factors of the common sub-pixels. For example, the “sub-region 3” of the “rectangle” comprises one sub-pixel and four common sub-pixels, the scale factor of the sub-pixel may be 0.6, and each of the scale factors of the four common sub-pixels may be 0.1. As another example, the “sub-region 3” of the “triangle” comprises one sub-pixel and two common sub-pixels, the scale factor of the sub-pixel may be 0.7, and each of the scale factors of the two common sub-pixels may be 0.15.

The reason why the scale factors should satisfy the above conditions is that, it ensures that overall brightness of the display panel does not change, and meanwhile, it is clear that the sub-pixel itself should have the “weight ratio” larger than those of the common sub-pixels, and thus the corresponding scale factor should be largest.

Of course, the selection method of the scale factors is not intended to limit the present invention. For example, the sum of the scale factors of a sub-pixel and the common sub-pixels may not be equal to 1. Further, although the scale factors of the common sub-pixels in the above examples are equal to each other, the scale factors of different common sub-pixels may be different (e.g., depending on distances from the common sub-pixels to the sub-pixel).

In addition, the display method may further comprise step S04 of performing above calculations on all sub-pixels to obtain the respective display components thereof, and causing the sub-pixels to display the respective display components thereof, so that the display panel displays desired pictures.

It could be understood that, the above implementation ways are merely exemplary embodiments adopted for describing the principle of the present invention, but the present invention is not limited thereto. Various modifications and improvements may be made by those of ordinary skill in the art without departing from the spirit and essence of the present invention, and these modifications and improvements are contemplated as within the protection scope of the present invention.

1-14. (canceled)

15. A display panel, comprising a plurality of circulation units, wherein
each circulation unit is composed of two rows of sub-pixels, the sub-pixels in each row include one red sub-pixel, one green sub-pixel and one blue sub-pixel, and
the sub-pixels in a first row are provided to shift by a half size of the sub-pixel in a row direction with respect to the sub-pixels in a second row, respectively, and an arrangement mode of the sub-pixels in the first row is different from that of the sub-pixels in the second row.

16. The display panel of claim 15, wherein
the sub-pixels in the first row are provided to shift by the half size of the sub-pixel in any one extending direction of two extending directions of the row direction with respect to the sub-pixels in the second row, respectively.

17. The display panel of claim 16, wherein the sub-pixels in the circulation unit has an arrangement mode of any one of the followings:
1) the first row from left to right orderly include R, B and G, and the second row from left to right orderly include G, R and B;
2) the first row from left to right orderly include B, R and G, and the second row from left to right orderly include G, B and R;
3) the first row from left to right orderly include B, G and R, and the second row from left to right orderly include R, B and G;
4) the first row from left to right orderly include G, B and R, and the second row from left to right orderly include R, G and B;
5) the first row from left to right orderly include G, R and B, and the second row from left to right orderly include B, G and R;
6) the first row from left to right orderly include R, G and B, and the second row from left to right orderly include B, R and G;
7) the first row from left to right orderly include R, B and G, and the second row from left to right orderly include G, B and R;
8) the first row from left to right orderly include B, R and G, and the second row from left to right orderly include G, R and B;
9) the first row from left to right orderly include B, G and R, and the second row from left to right orderly include R, G and B;
10) the first row from left to right orderly include G, B and R, and the second row from left to right orderly include R, B and G;
11) the first row from left to right orderly include G, R and B, and the second row from left to right orderly include B, R and G;
12) the first row from left to right orderly include R, G and B, and the second row from left to right orderly include B, G and R;
13) the first row from left to right orderly include R, B and G, and the second row from left to right orderly include B, G and R;
14) the first row from left to right orderly include B, R and G, and the second row from left to right orderly include R, G and B;
15) the first row from left to right orderly include B, G and R, and the second row from left to right orderly include G, R and B;
16) the first row from left to right orderly include G, B and R, and the second row from left to right orderly include B, R and G;
17) the first row from left to right orderly include G, R and B, and the second row from left to right orderly include R, B and G; and
18) the first row from left to right orderly include R, G and B, and the second row from left to right orderly include G, B and R,
wherein R indicates a red sub-pixel, G indicates a green sub-pixel, and B indicates a blue sub-pixel.

18. The display panel of claim 15, wherein
the circulation units are arranged into a matrix and throughout a display region of the display panel.

19. The display panel of claim 16, wherein
the circulation units are arranged into a matrix and throughout a display region of the display panel.

20. The display panel of claim 17, wherein
the circulation units are arranged into a matrix and throughout a display region of the display panel.

21. A display device, comprising a display panel, the display panel comprising a plurality of circulation units, wherein
each circulation unit is composed of two rows of sub-pixels, the sub-pixels in each row include one red sub-pixel, one green sub-pixel and one blue sub-pixel, and
the sub-pixels in a first row are provided to shift by a half size of the sub-pixel in a row direction with respect to the sub-pixels in a second row, respectively, and an arrangement mode of the sub-pixels in the first row is different from that of the sub-pixels in the second row.

22. The display device of claim 21, wherein
the sub-pixels in the first row are provided to shift by the half size of the sub-pixel in any one extending direction of two extending directions of the row direction with respect to the sub-pixels in the second row, respectively.

23. The display device of claim 22, wherein the sub-pixels in the circulation unit has an arrangement mode of any one of the followings:
1) the first row from left to right orderly include R, B and G, and the second row from left to right orderly include G, R and B;
2) the first row from left to right orderly include B, R and G, and the second row from left to right orderly include G, B and R;
3) the first row from left to right orderly include B, G and R, and the second row from left to right orderly include R, B and G;
4) the first row from left to right orderly include G, B and R, and the second row from left to right orderly include R, G and B;
5) the first row from left to right orderly include G, R and B, and the second row from left to right orderly include B, G and R;
6) the first row from left to right orderly include R, G and B, and the second row from left to right orderly include B, R and G;
7) the first row from left to right orderly include R, B and G, and the second row from left to right orderly include G, B and R;
8) the first row from left to right orderly include B, R and G, and the second row from left to right orderly include G, R and B;
9) the first row from left to right orderly include B, G and R, and the second row from left to right orderly include R, G and B;
10) the first row from left to right orderly include G, B and R, and the second row from left to right orderly include R, B and G;
11) the first row from left to right orderly include G, R and B, and the second row from left to right orderly include B, R and G;
12) the first row from left to right orderly include R, G and B, and the second row from left to right orderly include B, G and R;
13) the first row from left to right orderly include R, B and G, and the second row from left to right orderly include B, G and R;
14) the first row from left to right orderly include B, R and G, and the second row from left to right orderly include R, G and B;
15) the first row from left to right orderly include B, G and R, and the second row from left to right orderly include G, R and B;
16) the first row from left to right orderly include G, B and R, and the second row from left to right orderly include B, R and G;
17) the first row from left to right orderly include G, R and B, and the second row from left to right orderly include R, B and G; and
18) the first row from left to right orderly include R, G and B, and the second row from left to right orderly include G, B and R,
wherein R indicates a red sub-pixel, G indicates a green sub-pixel, and B indicates a blue sub-pixel.

24. The display device of claim 21, wherein
the circulation units are arranged into a matrix and throughout a display region of the display panel.

25. A display method of the display panel of claim 15, comprising steps of:
determining initial components of the sub-pixels according to a picture to be displayed; and
determining a display component of a sub-pixel according to the initial components of the sub-pixel and common sub-pixels of the sub-pixel, wherein the common sub-pixels of the sub-pixel are a plurality of sub-pixels around the sub-pixel and with the same color as the sub-pixel.

26. The display method of claim 25, wherein
the initial component and the display component are any one of brightness, grayscale and saturation.

27. The display method of claim 25, wherein, before determining the display component of the sub-pixel according to the initial components of the sub-pixel and common sub-pixels of the sub-pixel, the display method further comprises a step of:
determining the common sub-pixels of the sub-pixels according to the picture to be displayed.

28. The display method of claim 27, wherein the step of determining the common sub-pixels of the sub-pixels according to the picture to be displayed comprises:
determining the common sub-pixels by determining whether content of the picture to be displayed is a picture having uniform transition and little color change or a picture having large color change.

29. The display method of claim 25, wherein the step of determining the display component of the sub-pixel according to the initial components of the sub-pixel and common sub-pixels of the sub-pixel comprises:
multiplying the initial components of the sub-pixel and the common sub-pixels of the sub-pixel by respective scale factors, and summing up resulting values as the display component of the sub-pixel, wherein the scale factors of the sub-pixel and the common sub-pixels are positive numbers.

30. The display method of claim 29, wherein
the sum of the scale factors of the sub-pixel and the common sub-pixels thereof is 1, and the scale factor of the sub-pixel is larger than those of the common sub-pixels.

31. The display method of claim 25, wherein the common sub-pixels of the sub-pixel include:
four sub-pixels with the same color as the sub-pixel respectively in two rows adjacent to the row of the sub-pixel, and respectively on two sides of the sub-pixel in the row direction and closest to the sub-pixel.

32. The display method of claim 25, wherein the common sub-pixels of the sub-pixel include:
two sub-pixels with the same color as the sub-pixel respectively in two rows adjacent to the row of the sub-pixel, and on a same side of the sub-pixel in the row direction and closest to the sub-pixel.

33. The display method of claim 25, wherein the common sub-pixels of the sub-pixel include:
two sub-pixels with the same color as the sub-pixel in a row adjacent to the row of the sub-pixel, and respectively on two sides of the sub-pixel in the row direction and closest to the sub-pixel.
